(19) United States
(12) Patent Application Publication
(10) Pub. No.: US 2019/0256213 A1
(43) Pub. Date: Aug. 22, 2019

(54) DUCT AND METHOD FOR DIRECTING A FLOW OF AIR FROM AN AIR-COOLED DEVICE ONBOARD AN AIRCRAFT

(71) Applicants: BOMBARDIER INC., Dorval (CA); C SERIES AIRCRAFT LIMITED PARTNERSHIP, Mirabel (CA)

(72) Inventor: Hongzhi WANG, Saint-Laurent (CA)

(21) Appl. No.: 16/309,253

(22) PCT Filed: Jun. 8, 2017
(86) PCT No.: PCT/IB2017/053393

§ 371 Date: Dec. 12, 2018

Related U.S. Application Data
(60) Provisional application No. 62/349,706, filed on Jun. 14, 2016.

(51) Int. Cl. B64D 13/06

(52) U.S. Cl. CPC B64D 13/06; B64D 2013/064; B64D 2013/0625; B64D 2013/0614

(57) ABSTRACT

Ducts and methods for directing a flow of air from air-cooled devices onboard aircraft are disclosed. An exemplary method disclosed comprises: receiving air carrying heat extracted from the device, directing the air away from the device, and, discharging the air to at least one of an exterior of the aircraft and to an interior of the aircraft. A proportion of the air discharged to the exterior of the aircraft and to the interior of the aircraft is passively changed based on an operating condition such as the airspeed of the aircraft.

### CROSS-REFERENCE TO RELATED APPLICATION(S)

This International PCT Patent Application relies for priority on U.S. Provisional Patent Application Ser. No. 62/349,706 filed on Jun. 14, 2016, the entire content of which is incorporated herein by reference.

### TECHNICAL FIELD

The disclosure relates generally to air-cooled devices onboard aircraft, and more particularly to directing a flow of air from an air-cooled device onboard an aircraft.

### BACKGROUND OF THE ART

Aircraft commonly have equipment bays containing devices associated with various aircraft systems. Such devices may include avionics, hydraulic pumps, electric motors, etc. Some devices contained in aircraft equipment bays may be air-cooled and may require active convection cooling using a flow of air used to extract heat from the device and carry the heat away from the device.

In some situations, it may be desirable to discharge the heat-carrying air off-board the aircraft to prevent overheating of devices in the equipment bay. During flight of the aircraft however, the high-speed free stream of air flowing against the skin of the aircraft can cause some resistance to a flow of air being discharged off-board the aircraft through the skin of the aircraft via a duct. In order to overcome such resistance, one existing solution includes the use of relatively large, heavy and powerful ventilation equipment onboard the aircraft. Another existing solution includes the use of a forward lip (protrusion) disposed on the fuselage skin upstream of an outlet of the duct or of a recessed region formed in the fuselage skin for the outlet of the duct in order to reduce an external back pressure acting on the flow of air discharged off-board the aircraft. Even though the forward lip or the recessed outlet can facilitate the flow of air being discharged off-board the aircraft, they each entail a drag penalty for the aircraft.

### SUMMARY

In one aspect, the disclosure describes a duct for directing a flow of air carrying heat extracted from an air-cooled device onboard an aircraft. The duct comprises:

an inlet configured to receive the flow of air;

an exhaust outlet configured to discharge some of the air received at the inlet to an exterior of the aircraft; and

an orifice disposed upstream of the exhaust outlet and configured to discharge some of the air received at the inlet to an interior of the aircraft, both the exhaust outlet and the orifice being simultaneously in fluid communication with the inlet to passively change a proportion of air being discharged through the exhaust outlet and through the orifice based on an operating condition of the aircraft.

The orifice may be disposed closer to the exhaust outlet than to the inlet.

The orifice may be disposed on a substantially straight portion of the duct.

The duct may have a curved center line and the orifice may be disposed on a concave side of the duct.

The duct may be configured to be installed so that a portion of the duct adjacent the exhaust outlet is non-normal to a skin of the aircraft.

The duct may comprise a plurality of orifices configured to discharge some of the air received at the inlet to the interior of the aircraft.

The inlet may comprise a shroud configured to adapt to an end of an electric motor.

The operating condition of the aircraft may comprise an airspeed of the aircraft.

In another aspect, the disclosure describes an aircraft comprising a duct as disclosed herein.

In another aspect, the disclosure describes an equipment bay of an aircraft. The equipment bay comprises:
an aperture formed in a fuselage of the aircraft for permitting ambient air from an exterior of the aircraft to enter the equipment bay;
an air-cooled device; and
a duct for directing a flow of exhaust air carrying heat extracted from the device, the duct comprising:
   an inlet configured to receive the flow of exhaust air;
   an exhaust outlet configured to discharge some of the exhaust air received at the inlet to the exterior of the aircraft; and
   an orifice disposed upstream of the exhaust outlet and configured to discharge some of the exhaust air received at the inlet to an interior of the aircraft, both the exhaust outlet and the orifice being simultaneously in fluid communication with the inlet to passively change a proportion of exhaust air being discharged through the exhaust outlet and through the orifice based on an operating condition of the aircraft.

The orifice may be disposed closer to the exhaust outlet than to the inlet.

The orifice may be disposed on a substantially straight portion of the duct.

The duct may have a curved center line and the orifice may be disposed on a concave side of the duct.

A portion of the duct adjacent the exhaust outlet may be non-normal to a skin of the aircraft.

The duct may comprise a plurality of orifices configured to discharge some of the air received at the inlet to the interior of the aircraft.

The air-cooled device may comprise an electric motor and the inlet may comprise a shroud configured to adapt to an end of the electric motor.

The air-cooled device may comprise an integrated fan for driving the flow of exhaust air.

The operating condition of the aircraft may comprise an airspeed of the aircraft.

In another aspect, the disclosure describes an aircraft comprising an equipment bay as disclosed herein.

In a further aspect, the disclosure describes a method for directing a flow of air from an air-cooled device onboard an aircraft. The method comprises:

receiving air carrying heat extracted from the device;

directing the air away from the device; and

discharging the air to at least one of an exterior of the aircraft and to an interior of the aircraft where a proportion of the air discharged to the exterior of the aircraft and to the interior of the aircraft is passively changed based on an operating condition of the aircraft.

The method may comprise directing the air toward the exterior of the aircraft at least partially along a linear path and discharging the air to the interior of the aircraft in a direction transverse to the linear path.

The method may comprise discharging the air to the exterior of the aircraft substantially along the linear path.

The method may comprise directing the air toward the exterior of the aircraft at least partially along a curved path and discharging the air to the interior of the aircraft at a concave location of the curved path.

The method may comprise discharging the air to the interior of the aircraft at a plurality of locations.

The method may comprise discharging more air to the interior of the aircraft as the operating condition of the aircraft causes an increase in resistance to the air being discharged to the exterior of the aircraft.

The method may comprise discharging more air to the interior of the aircraft than to the exterior of the aircraft when the aircraft is in flight.

The method may comprise discharging more air to the exterior of the aircraft than to the interior of the aircraft when the aircraft is stationary.

The operating condition of the aircraft may comprise an airspeed of the aircraft.

Further details of these and other aspects of the subject matter of this application will be apparent from the drawings and detailed description included below.

### DESCRIPTION OF THE DRAWINGS

Reference is now made to the accompanying drawings, in which:

FIG. 1 is a perspective view of an exemplary aircraft comprising an equipment bay for containing one or more air-cooled devices;

FIG. 2 is a schematic representation of an exemplary equipment bay of the aircraft of FIG. 1;

FIG. 3 is a perspective view of a portion of an exemplary duct of the equipment bay of FIG. 2;

FIG. 4 is a schematic representation of the portion of the duct of FIG. 3;

FIG. 5A is an illustration of streamlines indicative of respective amounts of exhaust air being discharged via an exhaust outlet and an orifice of the duct of FIG. 3 when the aircraft is stationary;

FIG. 5B is an illustration of streamlines indicative of respective amounts of exhaust air being discharged via the exhaust outlet and the orifice of the duct of FIG. 3 when the aircraft is taking off;

FIG. 5C is an illustration of streamlines indicative of respective amounts of exhaust air being discharged via the exhaust outlet and the orifice of the duct of FIG. 3 when the aircraft is in flight;

FIG. 6 is a schematic view of a portion of another exemplary duct of the equipment bay of FIG. 2; and

FIG. 7 is a flowchart illustrating a method for directing air from an air-cooled device onboard the aircraft.

### DETAILED DESCRIPTION

This disclosure relates generally to directing a flow of air from air-cooled devices onboard an aircraft. For example, ducts and methods disclosed herein may be used to direct the flow of air carrying heat extracted from one or more devices onboard the aircraft and to discharge the air to one or both of an exterior of the aircraft and an interior of the aircraft depending on the operating condition of the aircraft. For example, in some embodiments of the disclosed ducts and methods, the proportion of air being discharged to the exterior and interior of the aircraft may be automatically and passively changed based on an operating condition of the aircraft. In some embodiments, the ducts disclosed herein may discharge more of the air to the exterior of the aircraft when the aircraft is stationary or the airspeed of the aircraft is relatively low, and, discharge more of the air to the interior of the aircraft when the airspeed of the aircraft is relatively high.

In some embodiments, the use of ducts and methods disclosed herein may reduce the need for relatively large, heavy and overly powerful ventilation equipment required to overcome the resistance offered by the high-speed free stream of air flowing against the outside of the skin of the aircraft. Accordingly, in some embodiments, ducts and methods disclosed herein may provide a relatively simple and low-weight solution for directing air from air-cooled devices onboard aircraft.

In some embodiments, the use of ducts and methods disclosed herein may entail lower drag penalties compared to those associated with a forward lip disposed on the fuselage skin upstream of an outlet of an exhaust duct or with a recessed region formed in the fuselage skin for the outlet of the exhaust duct. The use of ducts and methods disclosed herein may, in some embodiments, further reduce drag by reducing an amount of air entering and exiting an aircraft during a cruise phase of flight of the aircraft. For example, instead of discharging 100% of an air flow directed away from an air-cooled device and off-board the aircraft, the ducts and methods disclosed herein may allow for some or most of the flow of air to be re-ingested during cruise instead of being discharged off-board the aircraft. Such drag reduction can contribute toward improved fuel efficiency and range of an aircraft

Aspects of various embodiments are described through reference to the drawings.

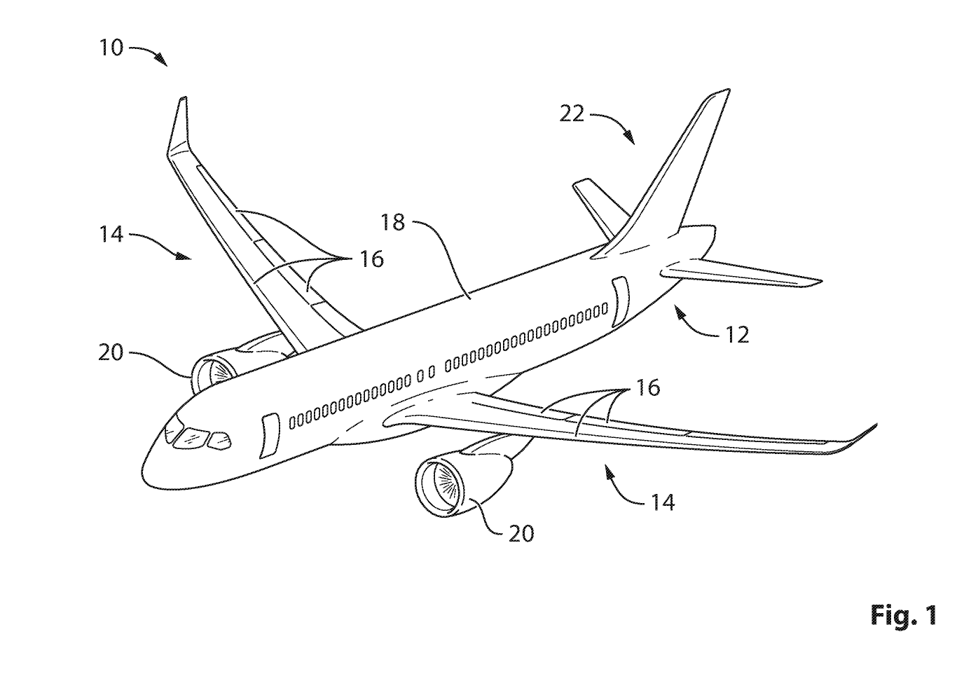

FIG. 1 is a perspective view of an exemplary aircraft 10 which may comprise an equipment bay generally shown at 12 as described below. Aircraft 10 may be any type of aircraft such as corporate (e.g., business jet), private, commercial and passenger aircraft. For example, aircraft 10 may be a narrow-body, twin-engine jet airliner. Aircraft 10 may be a fixed-wing aircraft. Aircraft 10 may comprise wings 14 including flight control surfaces 16, fuselage 18, engines 20 and empennage 22 of known or other type. One or more of engines 20 may be mounted to one or more of wings 14. Alternatively, or in addition, one or more of engines 20 may be mounted to fuselage 18 or be installed on aircraft 10 in any suitable manner.

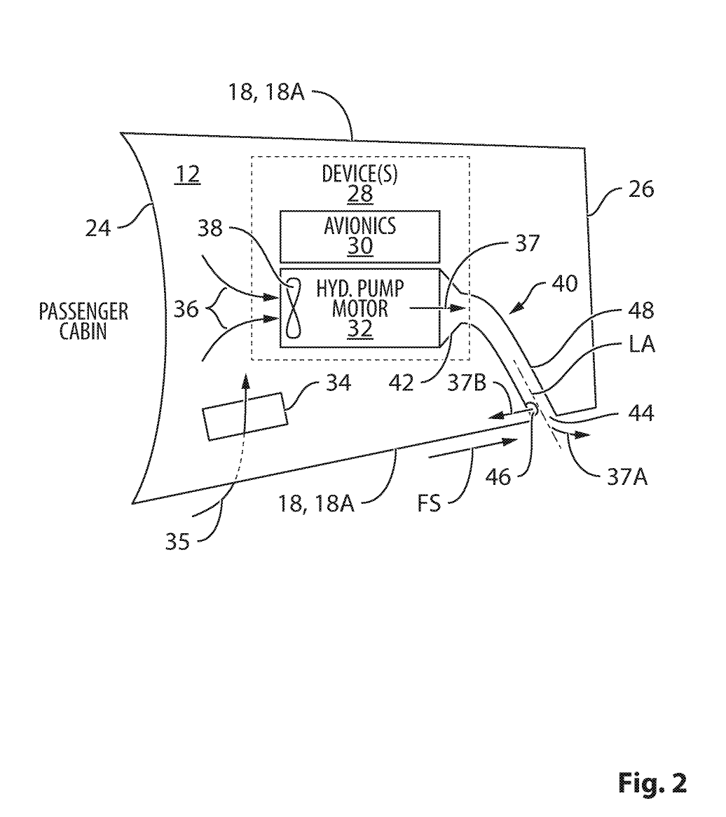

FIG. 2 is a schematic representation of an exemplary equipment bay 12 of aircraft 10. The particular equipment bay 12 illustrated in FIG. 2 is an aft equipment bay 12 disposed aft of a passenger cabin of aircraft 10. However, aspects of this disclosure may be equally applicable to air-cooled equipment located in other non-pressurised portions of aircraft 10. In some embodiments, equipment bay 12 may define a volume within a non-pressurized portion of aircraft 10. For example, equipment bay 12 may be defined in part by a forward pressure bulkhead 24 separating the pressurized passenger cabin from equipment bay 12. Equipment bay 12 may be further defined by aft bulkhead 26 and fuselage 18. Equipment bay 12 may, for example, also comprise any suitable non-pressurized zone within fuselage 18 such as a wing-to-body fairing and an avionics bay.

Equipment bay 12 may contain device(s) 28 associated with one or more systems of aircraft 10 that may be suitable for operation in a non-pressurized environment. For example, such devices 28 may include one or more avionic components 30, one or more electric motors 32, one or more hydraulic pumps and/or other devices. One or more devices 28 contained in equipment bay 12 may require cooling during at least one phase of operation of aircraft 10. For example, one or more of such devices 28 may require cooling air to be induced (i.e., active cooling) to flow past device(s) 28 to extract heat from device(s) 28 by way of convection and carry the heat away from device(s) 28 in order to keep such device(s) 28 within an acceptable temperature range. The exemplary and non-limiting device 28 requiring air cooling shown in FIG. 2 is electric motor 32 which may be coupled to drive a hydraulic pump associated with a hydraulic system of aircraft 10. However, it is understood that aspects of the present disclosure could be used in cooling other types of devices 28. It is also understood that aspects of the present disclosure could be used in cooling a plurality of devices 28 simultaneously.

In various embodiments, equipment bay 12 may comprise one or more apertures 34 (referred hereinafter in the singular) formed in fuselage 18 of aircraft 10 for permitting ambient air 35 from the exterior of aircraft 10 to freely enter equipment bay 12 and be used for cooling one or more devices 28 (e.g., electric motor 32 and avionic component 30). For example, aperture 34 may be defined by a grill, an inlet flush with skin 18A, or, a ram air inlet through which ambient air 35 may enter equipment bay 12. Electric motor 32 may comprise an integrated axial fan 38 or other type of fan(s) for producing the flow of cooling air 36 passing through electric motor 32. Alternatively, one or more non-integrated fans or blowers may be used to produce one or more flows of cooling air 36 over and/or through electric motor 32 and/or other device(s) 28 within equipment bay 12 to promote convection cooling. Equipment bay 12 may comprise duct 40 for directing a flow of exhaust air 37 (i.e., cooling air 36 carrying heat extracted from electric motor 32) away from electric motor 32. Exhaust air 37 may have a higher temperature than cooling air 36 and such higher temperature may depend on an amount of heat extracted from electric motor 32.

With respect to cooling electric motor 32, the flow of cooling air 36 may be induced (e.g., by integrated fan 38) to pass through (e.g., along an axial direction of) electric motor 32 to extract heat from electrical windings and/or bearings of electric motor 32, for example. Accordingly, duct 40 may comprise inlet 42 configured to receive the flow of exhaust air 37 downstream of electric motor 32 where the flow of exhaust air 37 may be carrying heat extracted from electric motor 32. In some embodiments, inlet 42 may comprise a shroud configured to adapt to an axial end of electric motor 32 so as to channel (e.g., funnel) the flow of exhaust air 37 into duct 40.

Duct 40 may be configured to direct the flow of exhaust air 37 away from electric motor 32 and discharge the flow of exhaust air 37 to one or both of the exterior of aircraft 10 and the interior of equipment bay 12 depending on an operating condition of aircraft 10. For example, duct 40 may comprise exhaust outlet 44 configured to discharge some of the exhaust air 37 received at inlet 42 to an exterior of aircraft 10 by discharging some of the exhaust air 37 through skin 18A of fuselage 18. The portion of exhaust air 37 discharged to the exterior of aircraft 10 is labelled using reference numeral 37A in FIG. 2. Duct 40 may also comprise orifice 46 disposed upstream of exhaust outlet 44 and configured to discharge some of the exhaust air 37 received at inlet 42 to an interior of equipment bay 12 (i.e. an interior of aircraft 10). The portion of exhaust air 37 discharged to the interior of aircraft 10 is labelled using reference numeral 37B in FIG. 2. Orifice 46 may reduce an overall downstream flow resistance to fan 38 and thereby increase the amount of air flow produced by fan 38 during one or more operating conditions of aircraft 10.

Both exhaust outlet 44 and orifice 46 may be simultaneously in fluid communication with inlet 42 during operation. For example, no valve and associated control system may be used to selectively open or occlude either inlet 42 or exhaust outlet 44 during operation. For example, both exhaust outlet 44 and orifice 46 may be permanently in fluid communication with inlet 42 during operation. As explained below, the presence of both exhaust outlet 44 and orifice 46 and the absence of any valve(s) controlling the flow through exhaust outlet 44 and orifice 46 may permit a proportion of exhaust air 37 being discharged through exhaust outlet 44 and through orifice 46 to be automatically and passively changed based on an operating condition of aircraft 10. In other words, the operation of duct 40 may be considered self-adaptive. For example, the proportion of exhaust air 37 being discharged through exhaust outlet 44 and through orifice 46 may be passively self-regulated based on an operating condition (e.g., airspeed) of aircraft 10. In some embodiments, such passive self-regulation of the flow proportion may be achieved without any moving parts.

During operation of aircraft 10, the velocity of the free stream of air FS flowing against skin 18A of aircraft 10 may vary based on the airspeed of aircraft 10. For example, when aircraft 10 is stationary or taxiing on the ground, the velocity of the free stream of air FS against skin 18A may be relatively low. Under such operating condition of aircraft 10, there may be little to no resistance for the flow of exhaust air 37 to flow out of exhaust outlet 44 and to the exterior of aircraft 10. Accordingly, under such condition, most of the exhaust air 37 may be discharged to the exterior of aircraft 10 due to the configuration of duct 40. In some embodiments, duct 40 may comprise a substantially straight (i.e., linear) portion 48 that is disposed immediately upstream of exhaust outlet 44. In some embodiments, orifice 46 may be disposed closer to exhaust outlet 44 than to inlet 42. It is understood that orifice 46 could be positioned at other suitable locations along duct 40 where, due to the momentum of exhaust air 37 flowing inside duct 40, the flow of exhaust air 37 would tend to flow mainly out of exhaust outlet 44 unless resistance offered by the free stream FS of air would cause the momentum of exhaust air 37 to be disrupted (e.g., by causing back pressure) and cause more of the exhaust air 37 to exit via orifice 46. In some embodiments, orifice 46 may be disposed proximal to an inside surface of fuselage 18 inside of equipment bay 12. The location of orifice 46 may be selected considering the expected temperature of exhaust air 37 to avoid local overheating of other device(s) 28 or other structure(s) within equipment bay 12. Orifice 46 may be a hole formed in a side wall of duct 40 within substantially straight portion 48 or at any other suitable location along duct 40. In various embodiments, duct 40 may have a circular or non-circular cross-sectional profile (e.g., rectangular, elliptical). In various embodiments, duct 40 or one or more portions thereof may have a cross-sectional profile that is constant or variable along its center line. Similarly, orifice 46 may have a circular or non-circular cross-sectional profile (e.g., rectangular, elliptical).

In some embodiments, orifice 46 may be substantially transverse to longitudinal axis LA of the substantially straight portion 48 of duct 40. Accordingly, in the situation where the resistance to the flow of exhaust air 37 out of exhaust outlet 44 is relatively low, most of the exhaust air 37 may flow past orifice 46 and out of exhaust outlet 44 instead of out of orifice 46 due in part to the momentum of the flow of exhaust air 37 in the substantially straight portion 48 being substantially along longitudinal axis LA and thereby reducing the likelihood for the exhaust air 37 to be diverted out of orifice 46. In this situation and in relation to FIG. 2, a mass flow rate of stream 37A of exhaust air 37 out of exhaust outlet 44 may be greater than a mass flow rate of stream 37B of exhaust air 37 out of orifice 46.

When aircraft 10 is on the ground and is either stationary or is moving at a relatively low speed, the cooling load for electric motor 32 and potentially of other device(s) 28 may be higher because of higher outside temperatures (i.e., higher temperature of cooling air 36), high solar load and a lower convection cooling rate with the ambient environment. The need for discharging exhaust air 37 to the exterior of aircraft 10 may be more important under such operating condition to prevent over heating of device(s) 28 within equipment bay 12. The use of duct 40 may be appropriate under such condition since the free stream of air FS may not offer much resistance to the flow of exhaust air 37 out of exhaust outlet 44.

On the other hand, when aircraft 10 is in flight (e.g., during a cruise phase of flight), the velocity of the free stream of air FS flowing against skin 18A of aircraft 10 may be relatively high. The relatively fast-moving free stream of air FS against skin 18A may form a barrier (i.e., a curtain of air) offering resistance (e.g., back pressure) to the flow of exhaust air 37A through exhaust outlet 44. Under such condition, orifice 46 may provide a suitable alternate path of least resistance for the flow of exhaust air 37 despite the transverse orientation of orifice 46 relative to a general flow direction of exhaust air 37 within duct 40. This may require the momentum of the flow of exhaust air 37 to be disrupted in order for the flow of exhaust air 37B to undergo a change in direction for exiting orifice 46. Nevertheless, in the situation where the resistance to the flow of exhaust air 37A out of exhaust outlet 44 is relatively high, most of the exhaust air 37 may be discharged out of orifice 46 instead of out of exhaust outlet 44. In this situation and in relation to FIG. 2, a mass flow rate of stream 37B of exhaust air 37 out of orifice 46 may be higher than a mass flow rate of stream 37A of exhaust air 37 out of exhaust outlet 44. Therefore, instead of requiring more powerful equipment to overcome the resistance from the free stream of air FS, the configuration of orifice 46 may provide an alternate flow path for the flow of exhaust air 37 without imposing excessive resistance on fan 38. Orifice 46 may be calibrated to offer a desired resistance to the flow of exhaust air 37 therethrough while still providing a suitable alternate path for a sufficient amount of exhaust air 37 based on the cooling requirements of electric motor 32.

When aircraft 10 is in flight and moving at a higher speed, the cooling load for electric motor 32 and other device(s) 28 within equipment bay 12 may be lower because of: (1) lower outside air temperatures (OAT) at higher altitudes and hence a higher convection cooling rate with the ambient environment inside of equipment bay 12; and, (2) a higher heat transfer coefficient with the outside air because of the higher speed of the outside air (i.e., free stream FS of air). Under such operating condition, the need for discharging exhaust air 37 to the exterior of aircraft 10 may be less important and the discharge of some of exhaust air 37 into equipment bay 12 via orifice 46 may not cause overheating of equipment bay 12.

In some situations, the heating of equipment bay 12 provided by exhaust air 37 being discharged via orifice 46 may be beneficial by making the environment inside of equipment bay 12 warmer and more equipment-friendly at higher altitudes and/or in colder climates.

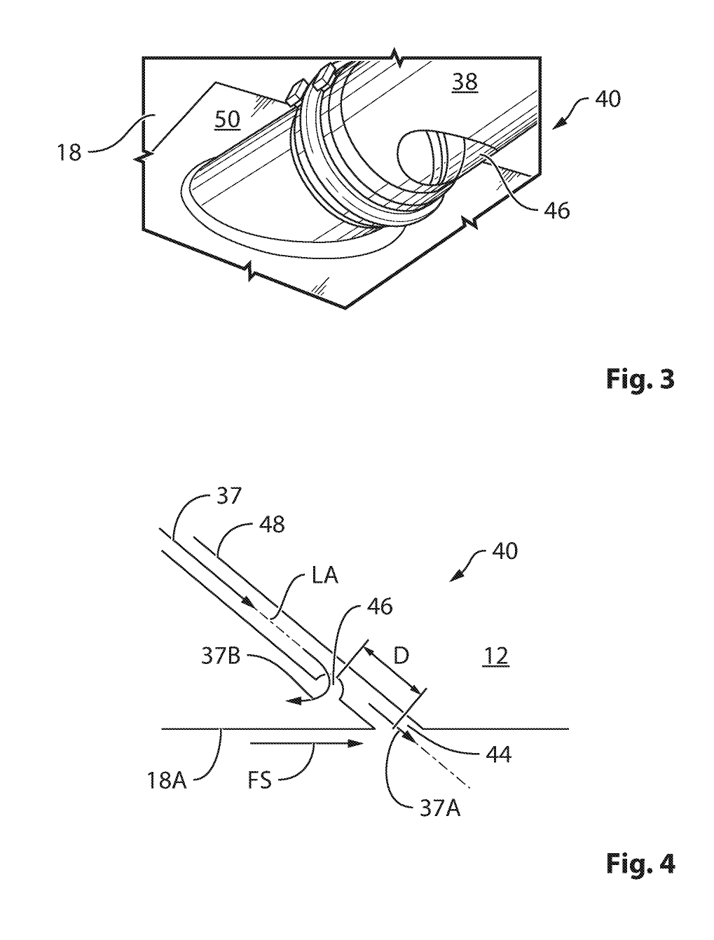

FIG. 3 is a perspective view of a portion of duct 40 of equipment bay 12 of aircraft 10. The portion of duct 40 shown is viewed from the inside of equipment bay 12 and is the portion that is interfacing with fuselage 18 in order to discharge exhaust air 37 through skin 18A and to the exterior of aircraft 10. As shown in FIG. 3, duct 40 may comprise a suitable adaptor 50 for interfacing duct 40 with fuselage 18.

FIG. 4 is a schematic representation of the portion of duct 40 shown in FIG. 3 showing the path taken by exhaust air 37A, 37B being discharged via exhaust outlet 44 and orifice 46 respectively. The size (e.g., area) and position (e.g., distance D) of orifice 46 may be selected so that an adequate flow rate of exhaust air 37 may be permitted to be discharged from duct 40 to provide adequate cooling capacity for electric motor 32 in different operating conditions (e.g., airspeed) of aircraft 10. For example, the size and position of orifice 46 may be selected so that orifice 46 does not permit too much exhaust air 37 to be re-ingested into the interior of aircraft 10 during ground operation so as to cause overheating of equipment bay 12. The size and position of orifice 46 may be selected to avoid local overheating within equipment bay 12 by exhaust air 37, which may have a relatively high temperature.

The adequate size and position of orifice 46 may be determined empirically and/or by numerical modeling according to known or other thermodynamic, pneumatic and computational fluid dynamic modelling methods based on cooling requirements for electric motor 32 and the expected environmental conditions. In some embodiments, orifice 46 may define a flow passage area that is about half the size of a flow passage area defined by the substantially straight portion 48 of duct 40. In some embodiments, duct 40 may comprise a plurality of orifices 46, which collectively may be sized and positioned to allow for a desired amount of exhaust air 37 to be re-ingested into equipment bay 12 at the appropriate time(s) and location(s).

As shown in FIG. 4, longitudinal axis LA of the substantially straight portion 48 of duct 40 may be non-normal to skin 18A of aircraft 10. For example, the substantially straight portion 48 of duct 40 may be inclined relative to skin 18A so that the flow of exhaust air 37A discharged via exhaust outlet 44 is partially directed in the same direction as the free stream of air FS flowing against skin 18A. For example, exhaust air 37A may have a component of its velocity vector in the same general direction as the free stream of air FS so as to reduce flow resistance and facilitate the flow of exhaust air 37A out of exhaust outlet 44. The inclination of the portion of duct 40 immediately upstream of exhaust outlet 44 may also reduce a drag penalty associated with discharging exhaust air 37A to the exterior of aircraft 10. In some embodiments, a suitable inclination angle between longitudinal axis LA and skin 18A may be about 45 degrees.

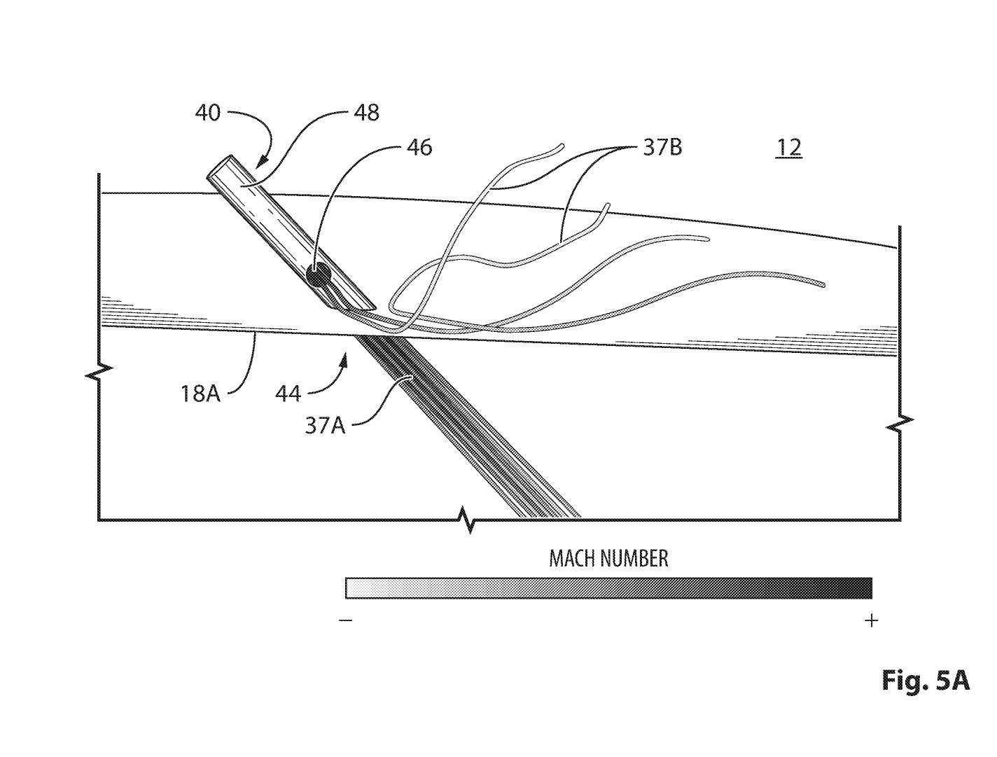

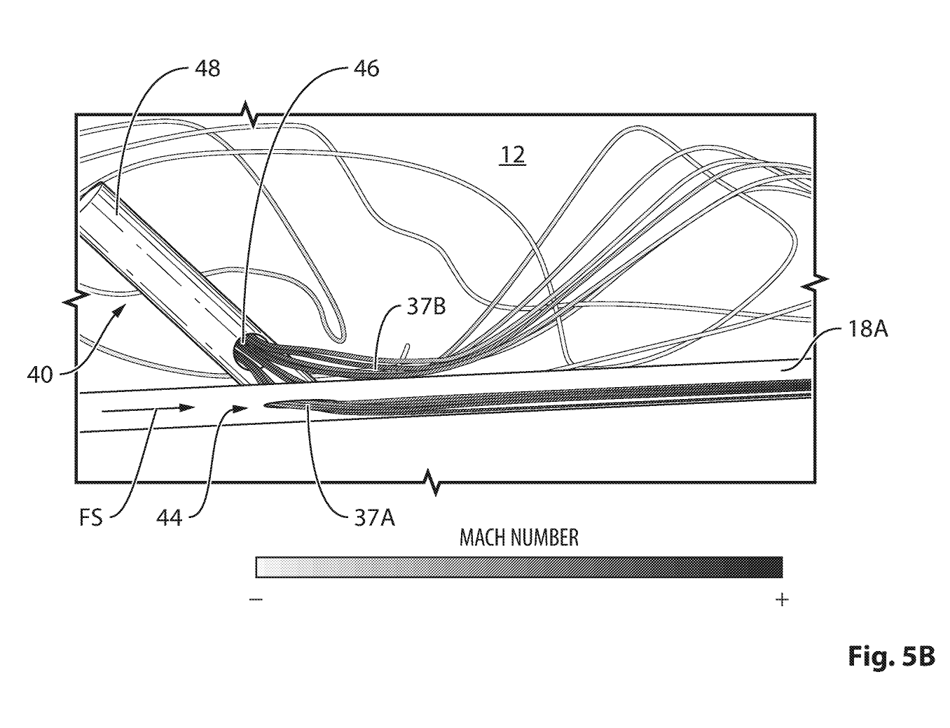

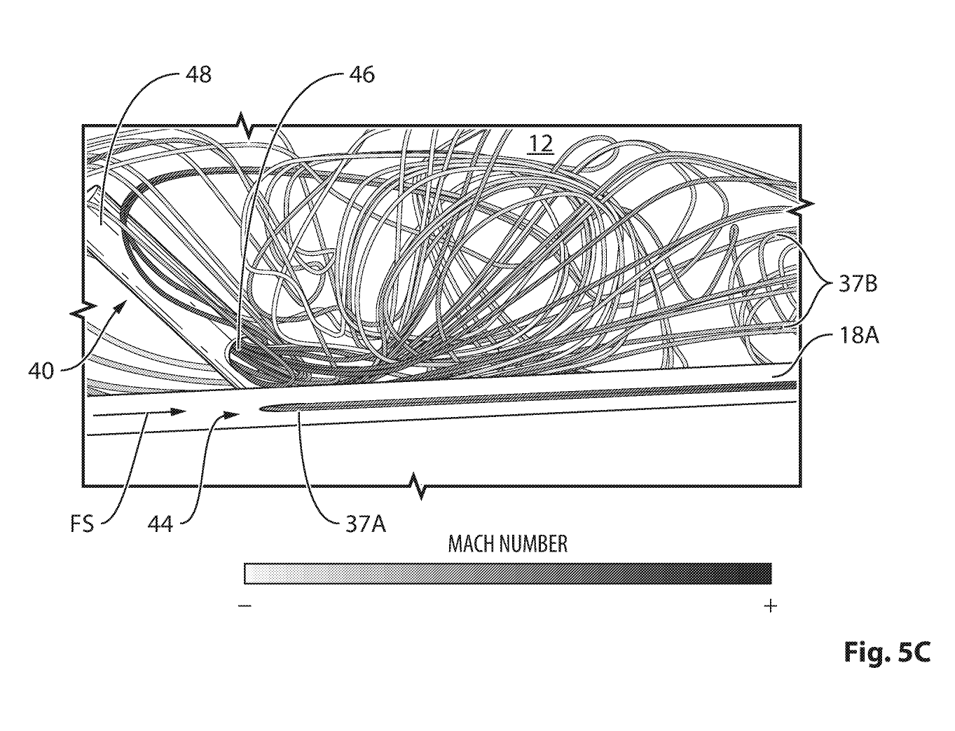

FIG. 5A is an illustration of streamlines computed using Computational Fluid Dynamics (CFD) software and indicative of respective amounts of exhaust air 37 being discharged via exhaust outlet 44 and via orifice 46 in a condition where aircraft 10 is stationary (e.g., on the ground). In this operating condition of aircraft 10, since there is little resistance to the flow of exhaust air 37 out of exhaust outlet 44, the streamlines indicate that most of exhaust air 37 is discharged via exhaust outlet 44 instead of orifice 46. In some embodiments a proportion of exhaust air 37 being re-ingested into equipment bay 12 via orifice 46 when aircraft 10 is stationary may, for example, be less than about 10%. In some embodiments, the proportion of exhaust air 37 being re-ingested into equipment bay 12 when aircraft 10 is stationary may, for example, be about 8%.

FIG. 5B is an illustration of streamlines computed using CFD software and indicative of respective amounts of exhaust air 37 being discharged via exhaust outlet 44 and via orifice 46 in a condition where aircraft 10 is moving at a moderate speed (e.g., during take-off). In this operating condition of aircraft 10, since there is moderate resistance to the flow of exhaust air 37 out of exhaust outlet 44, the streamlines indicate that more of exhaust air 37 is discharged via orifice 46 in comparison with the situation illustrated in FIG. 5A. In some embodiments a proportion of exhaust air 37 being re-ingested into equipment bay 12 via orifice 46 during take-off may, for example, be about 46%.

FIG. 5C is an illustration of streamlines computed using CFD software and indicative of respective amounts of exhaust air 37 being discharged via exhaust outlet 44 and via orifice 46 in a condition where aircraft 10 is moving at a relatively high speed (e.g., during cruise). In this operating condition of aircraft 10, since there is relatively high resistance to the flow of exhaust air 37 out of exhaust outlet 44, the streamlines indicate that more of exhaust air 37 is discharged via orifice 46 than via exhaust outlet 44. In some embodiments a proportion of exhaust air 37 being re-ingested into equipment bay 12 via orifice 46 during cruise may, for example, be greater than about 80%. In some embodiments, the proportion of exhaust air 37 being re-ingested into equipment bay 12 during cruise may, for example, be about 86%.

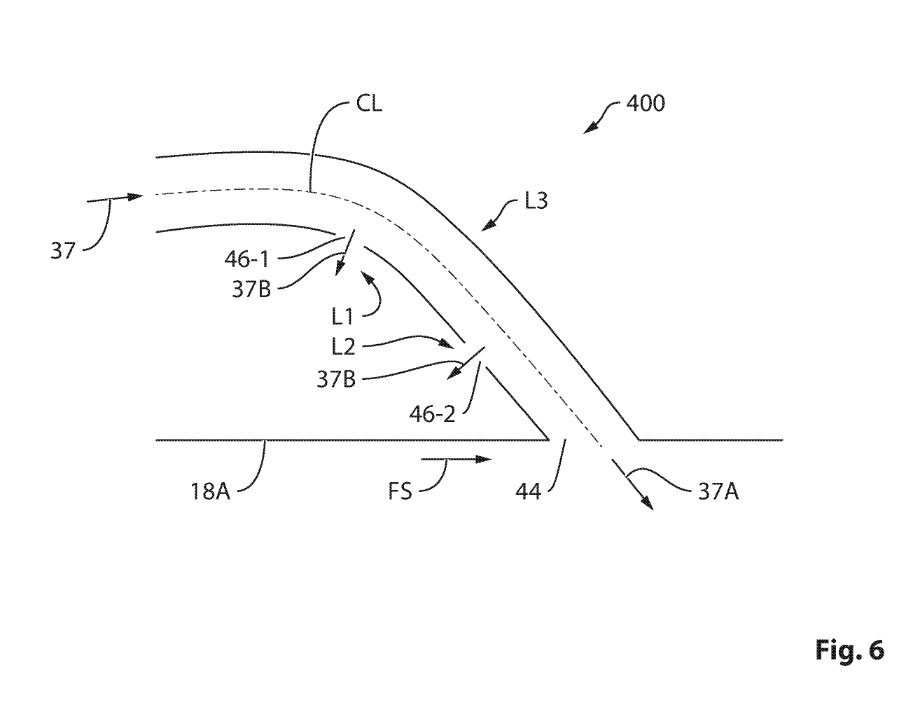

FIG. 6 is a schematic view of a portion of an exemplary duct 400 of equipment bay 12 according to another embodiment. Elements of duct 400 described above in relation to duct 40 are labelled using like reference characters.

As mentioned above, duct 400 may be curved as illustrated by center line CL and one or more orifices 46 may be disposed at different locations on duct 400. For example, one orifice 46-1 may be disposed at location L1 and another orifice 46-2 may be disposed at location L2. Orifices 46-1 and 46-2 may collectively allow some of exhaust air 37 to be discharged in the interior of aircraft 10. It is understood that several orifices 46 could be disposed on duct 400 to discharge exhaust air 37 at different locations and potentially at different rates in equipment bay 12 to avoid local overheating inside equipment bay 12. It is understood that, in some embodiments, several smaller orifices 46 may have a lesser impact on the structural integrity of duct 400 in comparison with one or more larger orifices 46.

Orifice(s) 46 may be disposed at locations requiring exhaust air 37 to undergo a change in direction from the general flow direction (e.g., along center line CL) of exhaust air 37 within duct 400. In other words, locations L1 and L2 may be locations where some disruption to the momentum of the flow of exhaust air 37 flowing along center line CL is required in order for some of exhaust air 37 to be re-directed through orifices 46-1 and 46-2 respectively. The magnitude of the disruption to the flow momentum of exhaust air 37 and hence the flow rate of exhaust air 37 through orifice(s) 46 may be a function of the magnitude of flow resistance provided by the free stream FS of air at exhaust outlet 44. Accordingly, the size(s) and position(s) of orifice(s) 46 may be selected to provide automated and passive control of the flow rate of exhaust air 37 being re-ingested into equipment bay 12 via orifice(s) 46 based at least partly on the flow resistance provided by the free stream FS of air at exhaust outlet 44 of duct 400. On a curved portion of duct 400 for example, it may be desirable to have orifice 46-1 be positioned on a concave side of duct 400 as indicated by reference character L1 as opposed to a convex side of duct 400 as indicated by reference character L3.

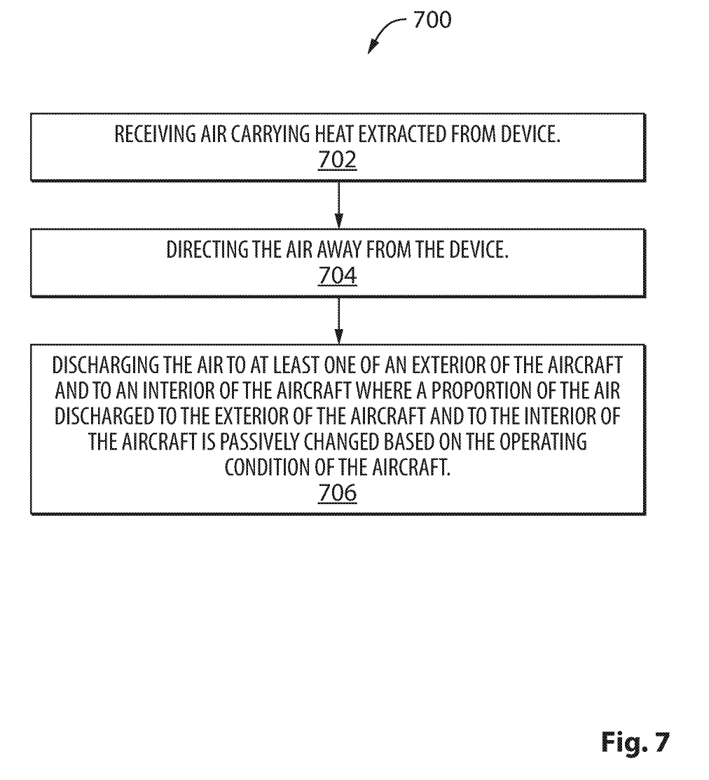

FIG. 7 is a flowchart illustrating a method 700 for directing the flow of exhaust air 37 used to cool device 28 (e.g., electric motor 32) onboard aircraft 10. In some embodiments, method 700 may be conducted using ducts 40 (see FIG. 4) or 400 (see FIG. 6) in equipment bay 12 as described above. Accordingly, aspects of ducts 40, 400 and equipment bay 12 described above may also apply to method 700 and vice versa. In various embodiments, method 700 may comprise: receiving exhaust air 37 carrying heat extracted from one or more devices 28 (see block 702); directing exhaust air 37 away from device 28 (see block 704); and discharging exhaust air 37 to at least one of an exterior of aircraft 10 and to an interior of aircraft 10 where a proportion of exhaust air 37 discharged to the exterior of aircraft 10 and to the interior of aircraft 10 is passively changed based on an operating condition of aircraft 10 (see block 706).

In some embodiments, method 700 may comprise directing the flow of exhaust air 37 toward the exterior of aircraft 10 at least partially along a linear path (e.g., see longitudinal axis LA in FIG. 4) and discharging exhaust air 37B to the interior of aircraft 10 in a direction transverse to the linear path. In some embodiments, method 700 may comprise discharging exhaust air 37A to the exterior of aircraft 10 substantially along the linear path. In some embodiments, the linear path may be non-normal to skin 18A of aircraft 10 as shown in FIG. 4.

In some embodiments, method 700 may comprise directing the flow of exhaust air 37 toward the exterior of aircraft 10 at least partially along a curved path (e.g., see center line CL in FIG. 6) and discharging the exhaust air 37B to the interior of aircraft 10 at a concave location L1 (see FIG. 6) of curved path CL.

In some embodiments, method 700 may comprise discharging exhaust air 37B to the interior of aircraft 10 at a plurality of locations L1, L2 as shown in FIG. 6.

In some embodiments, method 700 may comprise discharging more exhaust air 37 to the interior of aircraft 10 as the operating condition (e.g., airspeed) of aircraft 10 causes an increase in resistance (e.g., back pressure) to exhaust air 37 being discharged to the exterior of aircraft 10.

In some embodiments, method 700 may comprise discharging more exhaust air 37 to the interior of aircraft 10 than to the exterior of aircraft 10 when aircraft 10 is in flight or has a relatively high airspeed.

In some embodiments, method 700 may comprise discharging more exhaust air 37 to the exterior of aircraft 10 than to the interior of aircraft 10 when aircraft 10 is stationary or has a relatively low airspeed.

In some embodiments of method 700, the operating condition of aircraft 10 may comprise an airspeed of aircraft 10.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. The present disclosure may be embodied in other specific forms without departing from the subject matter of the claims. Also, one skilled in the relevant arts will appreciate that while the duct and equipment bay disclosed and shown herein may comprise a specific number of elements/components, the duct and, equipment bay and method could be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

1. A duct for directing a flow of air carrying heat extracted from an air-cooled device onboard an aircraft, the duct comprising:
an inlet configured to receive the flow of air;
an exhaust outlet configured to discharge some of the air received at the inlet to an exterior of the aircraft; and
an orifice disposed upstream of the exhaust outlet and configured to discharge some of the air received at the inlet to an interior of the aircraft, both the exhaust outlet and the orifice being simultaneously in fluid communication with the inlet to passively change a proportion of air being discharged through the exhaust outlet and through the orifice based on an operating condition of the aircraft.

2. The duct as defined in claim 1, wherein the orifice is disposed closer to the exhaust outlet than to the inlet.

3. The duct as defined in claim 1, wherein the orifice is disposed on a substantially straight portion of the duct.

4. The duct as defined in claim 1, wherein the duct has a curved center line and the orifice is disposed on a concave side of the duct.

5. The duct as defined in claim 1, wherein the duct is configured to be installed so that a portion of the duct adjacent the exhaust outlet is non-normal to a skin of the aircraft.

6. The duct as defined in claim 1, comprising a plurality of orifices configured to discharge some of the air received at the inlet to the interior of the aircraft.

7. The duct as defined in claim 1, wherein the inlet comprises a shroud configured to adapt to an end of an electric motor.

8. The duct as defined in claim 1, wherein the operating condition of the aircraft comprises an airspeed of the aircraft.

9. An aircraft comprising the duct as defined in claim 1.

10. An equipment bay of an aircraft, the equipment bay comprising:
an aperture formed in a fuselage of the aircraft for permitting ambient air from an exterior of the aircraft to enter the equipment bay;
an air-cooled device; and
a duct for directing a flow of exhaust air carrying heat extracted from the device, the duct comprising:
an inlet configured to receive the flow of exhaust air;
an exhaust outlet configured to discharge some of the exhaust air received at the inlet to the exterior of the aircraft; and
an orifice disposed upstream of the exhaust outlet and configured to discharge some of the exhaust air received at the inlet to an interior of the aircraft, both the exhaust outlet and the orifice being simultaneously in fluid communication with the inlet to passively change a proportion of exhaust air being discharged through the exhaust outlet and through the orifice based on an operating condition of the aircraft.

11. The equipment bay as defined in claim 10, wherein the orifice is disposed closer to the exhaust outlet than to the inlet.

12. The equipment bay as defined in claim 10, wherein the orifice is disposed on a substantially straight portion of the duct.

13. The equipment bay as defined in claim 10, wherein the duct has a curved center line and the orifice is disposed on a concave side of the duct.

14. The equipment bay as defined in claim 10, wherein a portion of the duct adjacent the exhaust outlet is non-normal to a skin of the aircraft.

15. The equipment bay as defined in claim 10, wherein the duct comprises a plurality of orifices configured to discharge some of the air received at the inlet to the interior of the aircraft.

16. The equipment bay as defined in claim 10, wherein the air-cooled device comprises an electric motor and the inlet comprises a shroud configured to adapt to an end of the electric motor.

17. The equipment bay as defined in claim 10, wherein the air-cooled device comprises an integrated fan for driving the flow of exhaust air.

18. The equipment bay as defined in claim 10, wherein the operating condition of the aircraft comprises an airspeed of the aircraft.

19. An aircraft comprising the equipment bay as defined in claim 1.

20. A method for directing a flow of air from an air-cooled device onboard an aircraft, the method comprising:
receiving air carrying heat extracted from the device;
directing the air away from the device; and
discharging the air to at least one of an exterior of the aircraft and to an interior of the aircraft where a proportion of the air discharged to the exterior of the aircraft and to the interior of the aircraft is passively changed based on an operating condition of the aircraft.

21. The method as defined in claim 20, comprising directing the air toward the exterior of the aircraft at least partially along a linear path and discharging the air to the interior of the aircraft in a direction transverse to the linear path.

22. The method as defined in claim 21, comprising discharging the air to the exterior of the aircraft substantially along the linear path.

23. The method as defined in claim 20, comprising directing the air toward the exterior of the aircraft at least partially along a curved path and discharging the air to the interior of the aircraft at a concave location of the curved path.

24. The method as defined in claim 20, comprising discharging the air to the interior of the aircraft at a plurality of locations.

25. The method as defined in claim 20, comprising discharging more air to the interior of the aircraft as the operating condition of the aircraft causes an increase in resistance to the air being discharged to the exterior of the aircraft.

26. The method as defined in claim 20, comprising discharging more air to the interior of the aircraft than to the exterior of the aircraft when the aircraft is in flight.

27. The method as defined in claim 20, comprising discharging more air to the exterior of the aircraft than to the interior of the aircraft when the aircraft is stationary.

28. The method as defined in claim 20, wherein the operating condition of the aircraft comprises an airspeed of the aircraft.
